(19) United States
(12) Patent Application Publication
(10) Pub. No.: US 2013/0217372 A1
(43) Pub. Date: Aug. 22, 2013

(54) SYSTEMS AND METHODS FOR FACILITATING CONVENIENT TELECONFERENCING BETWEEN USERS LOCATED IN DIFFERENT TIME ZONES

(71) Applicant: Tai Cheung Poon, Wanchai (HK)

(72) Inventor: Tai Cheung Poon, Wanchai (HK)

(21) Appl. No.: 13/398,805

(22) Filed: Feb. 16, 2012

(51) Int. Cl. H04W 4/00

(52) U.S. Cl. 455/416

(57) ABSTRACT

Systems and methods are disclosed for facilitating convenient teleconferencing between users located in different time zones. The system generally comprises three or more mobile devices with an associated server, processor and memory. The memory stores instructions that cause the processor to execute a method which generally involves an inviter proposing a first meeting time with two or more invitees. Based on the proposed time, an ideal time frame for the teleconference is presented to the inviter. The time frame is computed using data regarding the local times of each of the three attendees, thereby determining the most convenient time for all three to attend the teleconference. Once the meeting is started, the inviter reconfirms the current local times at the locations of the invitees. Subsequently, a meeting may be cut short if the local time of any attendees falls within a designated meal time or non-working time.

### FIELD OF THE INVENTION

This invention is generally related to global communications technology. More specifically, this invention is related to mobile teleconferencing.

### BACKGROUND OF THE INVENTION

Global effort cannot be avoided in today's business world. A business team is required to work together, even though team members may come from different parts of the world. When a meeting or teleconference is organized, the organizer of the meeting or teleconference is asked to make sure that each intended participant is available. The organizer tends to check the calendar of each of such participants to determine a period of time that would fit the schedule of everyone. The task is easy if everyone to be invited comes from the same area.

However, when one participant resides in one time zone while the other resides in a different time zone, scheduling of a meeting can become even more challenging because the local time of the organizer can be very different than that of the participants. As an example, if the organizer resides in the North American Eastern Time Zone whereas a participant is located in China Standard Time Zone, there will be an 11 hour difference. Thus, day time for the organizer would equate night time for participant. Therefore, if the organizer has no knowledge about the time zone of the participant, the intended meeting or teleconference can be quite undesirable and inconvenient for the participants residing in different time zones, even though the schedule may show that the participants are available at a certain time.

Knowing ahead of time when scheduling a meeting regarding the local time equivalent can be quite crucial to avoid any inconvenience and disrespect caused to the participants. Moreover, if there are multiple invitees to a teleconference, it may be difficult to plan the meeting even if all of the local time zones of the participants are known

As a result, in view of the foregoing, there is a need unfulfilled in the art for systems and methods that enable a meeting organizer to schedule a teleconference in view of current time zones of the intended invitees.

### SUMMARY OF THE INVENTION

According to embodiments of the invention, a system for facilitating convenient teleconferencing between users located indifferent time zones is provided. The system's components include a first, second, and third mobile device. The system also comprises memory, a processor, and a server that is responsible for storing data pertaining to the teleconference. The first mobile device is carried by a first user, who is an inviter of a teleconference, and resides in a first time zone. The second and third mobile devices belong to second and third users who reside in different time zones.

The memory comprises instructions that cause the processor to execute a method which comprises the following steps. The first step involves prompting the first user to propose a time for a teleconference with the second and third users. Then, providing the first user with ideal scheduling time frames in order to minimize inconvenience to the second and third users in light of the proposed time of the teleconference, current locations of the second and third users, and current time zones associated with the current locations of the second and third users. In order to carry this step out the first user is presented with data comprising: a) current locations of the second and third users, wherein the current locations are provided via the GPS receivers of the second and third mobile devices respectively; b) current time zones of the second and third users, the time zones being computed using the current location data; and c) current local times at the second and third users.

If the current local times of the second and third users are outside working hours in view of local times, then the proposed time of the teleconference is rejected. Instead, another time is proposed that can best accommodate the time zone differences of the first, second and third users.

The method proceeds when the teleconference has begun. Upon beginning the teleconference, the first user is enabled to reconfirm the current times of the second and third users. The step of reconfirming includes: a) listing all users attending the teleconference; b) listing current locations of the second and third users, wherein the current locations are provided via the GPS receivers of the second and third mobile devices respectively; c) listing current time zones of the second and third users, determination of the current time zones being based on the current locations; d) listing current local times of the second and third users; and e) highlighting if the current local times of the second and third users are outside working hours, in view of local times.

In embodiments of the disclosed invention, the data regarding locations, time zones, and local times may be determined by the server. In further embodiments an additional step may be included of reducing the length of the teleconference if the local times of either of the second or third users are outside of working hours.

It is, therefore, an objective of the disclosed invention to provide a system and method for minimizing mobile phone roaming charges during international calls.

In accordance with these and other objects which will become apparent hereinafter, the invention will now be described with particular reference to the drawing.

### BRIEF DESCRIPTION OF THE DRAWINGS

FIG. 1 shows a flow diagram outlining a method of setting up a teleconference according to an embodiment of the present invention.

### DETAILED DESCRIPTION

Referring now to the FIGURE, a flow diagram outlining a method of setting up a teleconference is shown. Generally, a system for facilitating convenient teleconferencing between users located indifferent time zones is provided. The system's components include a first, second, and third mobile device. The system also comprises memory, a processor, and a server that is responsible for storing data pertaining to the teleconference. The first mobile device is carried by a first user, who is an inviter of a teleconference, and resides in a first time zone. The second and third mobile devices belong to second and third users who reside in different time zones.

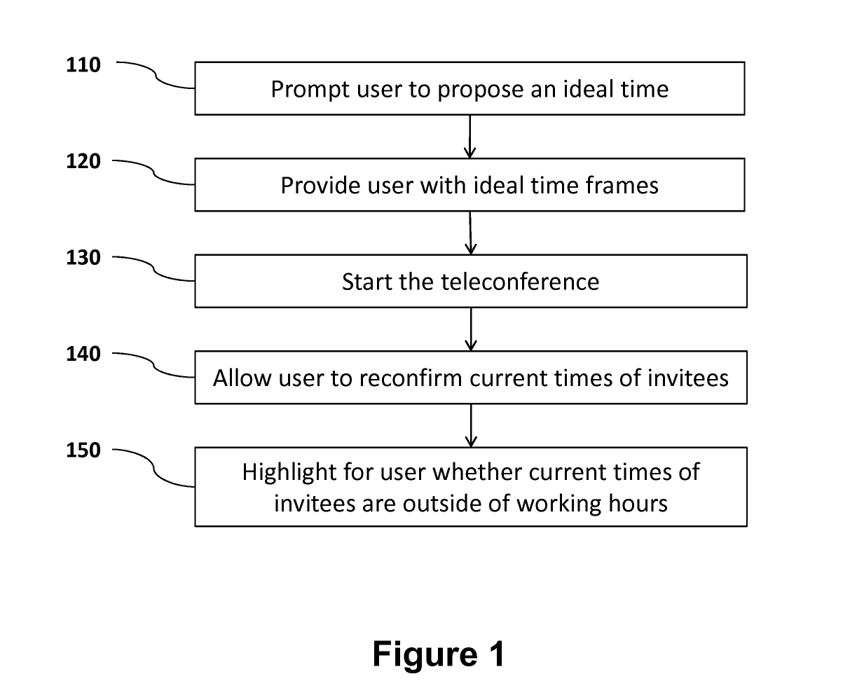

Referring still to FIG. 1, the memory comprises instructions that cause the processor to execute a method which comprises the following steps. The first step 100 involves prompting the first user to propose a time for a teleconference with the second and third users. Step two 120 involves providing the first user with ideal scheduling time frames in order to minimize inconvenience to the second and third users in light of the proposed time of the teleconference, current locations of the second and third users, and current time zones associated with the current locations of the second and third users.

In order to carry this step out the first user is presented with data comprising: a) current locations of the second and third users, wherein the current locations are provided via the GPS receivers of the second and third mobile devices respectively; b) current time zones of the second and third users, the time zones being computed using the current location data; and c) current local times at the second and third users.

For example, suppose that the first user resides in New York, the second in Beijing, and the third in Tokyo. The first user may propose a time of 3:00 P.M. North American Eastern Time Zone (EST). This would correspond to a time of 4:00 A.M. in Beijing (CST) and 5:00 A.M. in Tokyo (JST). This meeting would obviously be too early for the meeting invitees on the Asian Continent. Thus, the system may propose a more convenient meeting time frame between, for example, 6:30 P.M. EST and 8:30 P.M. EST. This would surmount to 7:30-9:30 A.M. CST and 8:30-10:30 A.M. JST. This two hour interval would be the ideal window for a teleconference because the local times in the locations of all three meeting attendees would be within reasonable working hours.

If the current local times of the second and third users are outside working hours in view of local times, then the proposed time of the teleconference is rejected. Instead, another time is proposed that can best accommodate the time zone differences of the first, second and third users. In the above example, the proposed alternative meeting time may be, for example 7:30 P.M. EST, which is 8:30 A.M. CST and 9:30 A.M. JST. This time being ideal and convenient for all three attendees.

The method proceeds when the teleconference has begun 130. Upon beginning the teleconference, the first user is enabled to reconfirm the current times of the second and third users 140. The step of reconfirming includes: a) listing all users attending the teleconference; b) listing current locations of the second and third users, wherein the current locations are provided via the GPS receivers of the second and third mobile devices respectively; c) listing current time zones of the second and third users, determination of the current time zones being based on the current locations; d) listing current local times of the second and third users; and e) highlighting 150 if the current local times of the second and third users are outside working hours, in view of local times. These steps may be carried out via the mobile device's display. Software installed on the mobile device may be employed to facilitate the steps, and display the data on the mobile device's display.

In embodiments of the disclosed invention, the data regarding locations, time zones, and local times may be determined by the server. This would involve the mobile device communicated with the server via a wireless network. In further embodiments an additional step may be included of reducing the length of the teleconference if the local times of either of the second or third users are outside of working hours. In the aforementioned example, the teleconference may be ended automatically at 8:30 P.M. EST because this time may be too late and therefore inconvenient for the user residing in New York.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A system for facilitating convenient teleconferencing between users located in different time zones, comprising:
a first mobile device being carried by a first user who is an inviter of a teleconference, and is residing in a first time zone, the first user being a leader;
a second mobile device being carried by a second user who is an invitee of the teleconference, and is residing in a second time zone, the second user being a follower;
a third mobile device being carried by a third user who is an invitee of a teleconference, and is residing in a third time zone, the third user being a follower;
the first, second, and third mobile devices each comprising a GPS receiver;
a server responsible for storing data pertaining to the teleconference;
a processor; and
memory storing instructions that cause the processor to execute a method, the method comprising:
prompting the first user to propose a time for a teleconference with the second and third users;
providing the first user with ideal scheduling time frames in order to minimize inconvenience to the second and third users in light of the proposed time of the teleconference, current locations of the second and third users, and current time zones associated with the current locations of the second and third users, wherein the first user is presented with data comprising:
current locations of the second and third users, wherein the current locations are provided via the GPS receivers of the second and third mobile devices respectively;
current time zones of the second and third users, the time zones being computed using the current location data;
current local times at the second and third users;
if the current local times of the second and third users are outside working hours in view of local times:
rejecting the proposed time of the teleconference by the first user; and
proposing another time that can accommodate the time zone differences of the first user, second user, and third user to avoid having the second and third users to attend the teleconference outside working hours; and
during the teleconference:
allowing the first user to reconfirm the current times of the second and third users, wherein the reconfirming includes:
listing all users attending the teleconference;
listing current locations of the second and third users, wherein the current locations are provided via the GPS receivers of the second and third mobile devices respectively;
listing current time zones of the second and third users, determination of the current time zones being based on the current locations,;
listing current local times of the second and third users; and
highlighting if the current local times of the second and third users are outside working hours, in view of local times.

2. The system of claim 1, wherein the data presented to the first user regarding locations, time zones, and times is determined by the server.

3. The system of claim 1, wherein the method further comprises a step of reducing the length of the teleconference if the local times of either of the second or third users are outside of working hours.

4. The system of claim 2, wherein the method further comprises a step of reducing the length of the teleconference if the local times of either of the second or third users are outside of working hours.

5. A system for facilitating convenient teleconferencing between users located in different time zones, comprising:
a first mobile device being carried by a first user who is an inviter of a teleconference, and is residing in a first time zone, the first user being a leader;
a second mobile device being carried by a second user who is an invitee of the teleconference, and is residing in a second time zone, the second user being a follower;
a third mobile device being carried by a third user who is an invitee of a teleconference, and is residing in a third time zone, the third user being a follower;
the first, second, and third mobile devices each comprising a GPS receiver;
a server responsible for storing data pertaining to the teleconference;
a processor; and
memory storing instructions that cause the processor to execute a method, the method comprising:
prompting the first user to propose a time for a teleconference with the second and third users;
providing the first user with ideal scheduling time frames in order to minimize inconvenience to the second and third users in light of the proposed time of the teleconference, current locations of the second and third users, and current time zones associated with the current locations of the second and third users, wherein the first user is presented with data comprising:
current locations of the second and third users, wherein the current locations provided via server by the GPS receivers of the second and third mobile devices respectively;
current time zones of the second and third users, the time zones being computed by the server using the current location data;
current local times at the second and third users as provided by the server;
if the current local times of the second and third users are outside working hours in view of local times:
rejecting the proposed time of the teleconference by the first user; and
proposing another time that can accommodate the time zone differences of the first user, second user, and third user to avoid having the second and third users to attend the teleconference outside working hours; and
during the teleconference:
allowing the first user to reconfirm the current times of the second and third users, wherein the reconfirming includes:
listing all users attending the teleconference;
listing current locations of the second and third users, wherein the current locations are provided via the GPS receivers of the second and third mobile devices respectively;
listing current time zones of the second and third users, determination of the current time zones being based on the current locations;
listing current local times of the second and third users; and
highlighting if the current local times of the second and third users are outside working hours, in view of local times;
reducing the length of the teleconference if the local times of either of the second or third users are outside of working hours; and
stopping the teleconference if local times of either second or third users are during a designated meal time, and resuming after the meal time, in light of the current time zones of the second and third users.

6. A method for facilitating convenient teleconferencing between users located in different time zones, comprising the following steps:
providing at least three mobile phones and a server capable of remotely exchanging data between the mobile phones, wherein each mobile phone comprises a GPS receiver and data connectivity;
initiating a teleconference call with a first mobile phone of the mobile phones, a user of said first mobile phone proposing a time and invitees for said teleconference, each of said invitees being associated with one of the mobile phones;
upon selection of teleconference invitees, determining, with the server, the respective time zones and local times of invitees based on GPS receivers of respective mobile phones;
providing to the user of the first mobile phone the data regarding time zones and local times of invitees; and
if the proposed teleconference call is outside of working hours of any of the invitees, proposing with the server, an alternative time for the call that is convenient for all invitees.

7. The method of claim 6, further comprising a step of:
reducing the length of the teleconference if the local times of any of the invitees are outside of working hours.

8. The method of claim 6, further comprising a step of:
reducing the length of the teleconference if the local times of any of the invitees is during a designated meal time.
